(19) United States
(12) Patent Application Publication
(10) Pub. No.: US 2008/0010456 A1
(43) Pub. Date: Jan. 10, 2008

(54) Communication between a smart card and a server

(76) Inventor: Jacques Seif, Puteaux (FR)

Correspondence Address: OSHA LIANG L.L.P., 1221 MCKINNEY STREET, SUITE 2800, HOUSTON, TX, 77010, US

(21) Appl. No.: 10/543,936

(22) PCT Filed: Jan. 30, 2004
(86) PCT No.: PCT/IB04/00223

§ 371 Date: Aug. 1, 2005

(30) Foreign Application Priority Data
Jan. 31, 2003 (EP) 03290249.6

(51) Int. Cl. G06Q 99/00; H04L 9/00; H04K 1/00

(52) U.S. Cl. 713/169; 705/64

(57) ABSTRACT

The invention deals with a communication between a smart card (CAR) and a server (SERV) by way of a network (RES). The smart card communicates with this server by way of a communication system such as a mobile phone. The mobile phone (MOB) stores at least one object defining a respective service. Each object is defined by a class including at least one attribute. The invention comprises the following steps: a preliminary step in which an object is created in the smartcard (CAR), said object including at least one subscriber attribute; a loading step in which said object is loaded in the mobile phone; a using step in which said server (SERV) uses said object for performing security checking and getting information.

### TECHNICAL FIELD

This invention relates to electronic data exchange mechanisms and more particularly to communications between a first data processing system and a tamper resistant device such as a smart card. Smart card communicates with the first system through a second data processing system such as a personal digital assistants (PDA), notebook computers, mobile phones, computer games, electronic books, pagers, etc., here generically called “portable devices”.

The smartcard could be, for example, a SIM (Subscriber Identity Module) integrated circuit card or a USIM (Universal Subscriber Identity Module) integrated circuit card. The example chosen to illustrate the invention is that of the USIM integrated circuit card hereinafter abbreviated to UICC card.

The invention is not limited to SIM or USIM cards but can be extended to any emerging or future tamper resistant device whose use would be similar to that of the SIM card use.

The invention also particularly applies to systems where it exists at least two different communication protocols and where at least one of the two protocols is an object-oriented protocol. In our illustrated example, said second data processing system is an external device using known IrDa (Infrared Data Association) protocol.

### PRIOR ART

For more details about IrDa, we will refer to the following standard: Infrared Data Association—Link Management Protocol—Version 1.1-23 Jan. 1996, herewith incorporated by reference to the description.

The USIM Application Toolkit (USAT), defined by ETSI in the following standards 3GPP TS 31.111 and See TS 102 223 also incorporated by reference to the description, provides a standardized execution environment for applications stored on the UICC card and ability to utilize certain functions of the supporting mobile equipment. USAT provides mechanisms which allow applications stored in the UICC card to interact and operate with mobile phones supporting these mechanisms.

USAT Mechanisms includes Proactive USIM. Proactive UICC provides mechanism for UICC to initiate actions to be taken by the mobile. By this mechanism UICC cards can establish and maintain an interactive dialogue with the user and communicate with the network or an external device. Proactive actions include displaying text from the SIM to the ME, sending a short message, initiating a dialogue with the user, USIM initialisation request, providing local information from the mobile phone to the UICC card, communicating with the additional card(s), providing information about the additional card reader(s), managing timers running physically in the mobile, requesting the ME to launch the browser corresponding to a URL, . . . , and establishing and managing a bearer independent protocol (BIP).

Bearer Independent Data Transfer, using local bearers, is a USAT feature that allows a USAT application stored inside the UICC card to request the mobile to set up and manage a data channel over local links such as IrDA (or Bluetooth, IrDA, RS232 or USB) using information provided by the USAT application. Once the channel is open (local link), data may be transferred through the open channel. The details for the interface between USIM-USAT and the mobile are specified in 3GPP TS 31.101, 31.102, and 31.111. The Service Requirements for this are specified in 3GPP TS 22.038.

Nevertheless, communication protocol between the ICC card and the mobile is not the same as the one between the mobile and the external device. IrDa protocol is an object protocol using class objects, attributes. According to IrDa specfication, each service is defined by mean of an object. According to the standard, an object has a class name, an identifier that uniquely specifies the object within the device, and a number of attributes. An attribute is a name-value pair. The name is a length-encoded sequence of octets. The value is a typed field, with a length field if the type is not of fixed length, and a sequence of octets comprising the actual value.

In the other side, the protocol between the UICC card and the Mobile phone is the above BIP (Bearer Independent Protocol) protocol.

This is a problem when the external device has to authenticate or identify a subscriber/user. Due to protocols heterogeneity, the external device can't communicate with the UICC card for getting subscriber personal information needed for authentication/identification steps.

### THE INVENTION

An objective is therefore to allow the user to be authenticated or identified by an external device using information stored inside said UICC card without modifying the existing protocols.

Generally, in order to achieve this objective, the solution includes the following steps:
A preliminary step in which an object is created in the smartcard, said object including at least one subscriber attribute;
A loading step in which said object is loaded in the mobile phone;
A using step in which said external device uses said object for getting information stored in the smart card.

In this way, this new object is stored in a secure environment (the smartcard) and loaded, when requested, in the mobile for being used by the external device. The program stored in the smartcard only has to perform a loading of this object into the mobile. So, no protocol has to be created between the couple UICC/mobilephone card and the external device.

It will be easier to understand the invention on reading the description below, given as an example and referring to the attached drawing.

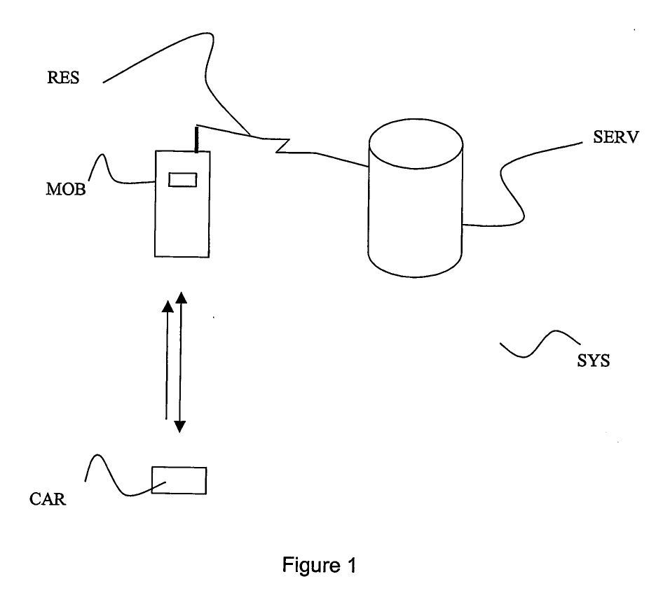

In the drawing, FIG. 1 is a general view of a system in which the invention can be implemented.

### DETAILED DESCRIPTION OF A PRACTICAL EXAMPLE

In our illustrated example, the system includes a mobile phone MOB coupled to a smartcard CAR. The mobile phone communicates with a external device including services by way of a network RES.

FIG. 1 illustrates a system SYS including a mobile phone MOB coupled to a UICC card CAR. System SYS also comprises a external device SERV. In our example, the external device SERV communicates with the mobile phone MOB by way of infrared (IrDa).

In our illustrated example, the external device SERV needs to authenticate the UICC card. According to the invention, a new class is created. For example, this new class can be called “SmartCard”. The class attributes will store personal information such as name, number, certificates, and other information attached to a subscriber.

All these items are stored as attributes and are called subscriber attributes.

The corresponding object is stored in the smart card.

The following steps will help to understand how is used the object stored inside the card CAR.

Step1

In a first step, the user activates the service stored in the smartcard by way of his mobile phone MOB. In our example, this service is a SIM toolkit applet. To activate the service, the client can for example press on a menu able to activate an IrDA identification service.

Step 2

In a second step, the service loads the object “smartcard” in the mobile phone MOB. The object “smartcard” is added to the mobile phone IAS entries. In our example, a command called “DECLARE SERVICE” in the above-identified BIP protocol is used to add this object.

As defined in the above identified standard: Infrared Data Association—Link Management Protocol—Version 1.1, each IrDA device provides an Information Access Service (IAS). The IAS maintains information about the services provided by this IrDA device and also provides operations for remotely accessing the information base on another device. This information is needed so that clients on a remote device can find configuration information needed in order to access a service.

The Bearer Independent Protocol BIP defines a proactive command “DECLARE SERVICE”, which allows the UICC card to add or delete a service into the mobile. Command DECLARE SERVICE enables the UICC card to add an entry into the mobile (IAS [Information Access Service]). In our example, this object is called “smartcard”.

Step 3

In a third step, the user requests a service to the external device SERV. In our example, this external device is an IrDA server.

To be noted that flow direction of steps 2 and 3 is indifferent. Step 3 could be executed before step 2.

Step 4

In a fourth step, the user can point his mobile phone towards the IrDA external device to identify himself. For instance, the IrDA external device can be a gate or a vending machine. It can also be a external device that hosts a fidelity application.

Advantageously, the connection between the mobile and the external device is directional. In our example an Infrared connection is used. So, when the user activates a service, use of service requires the user effort to point his device towards the second data processing system. Consequently use of directional link adds another layer of security.

Step 5

In our example, in a fifth step, the IrDA external device performs GetValueByClass (address, SmartCard, requested parameter) operations to get identification information. In this operation, the field called “Smartcard” corresponds to the above-defined object. In this step, the external device becomes a client and the mobile has a role of server.

In our example we have chosen to use LM_GetValueByClass operation because this operation is supported by most IrDa devices.

Step 5 bis

Let's consider that the object attributes include attributes which values are able to launch a service in the second data processing system SERV. In a step 5 bis, the external device can launch a service automatically. This auto-launch will save user effort to search for the application menu and to select a service. Consequently, this will reduce service time and will save user time.

We see now that the invention offers various advantages.

Firstly, the invention is simple and inexpensive because this solution avoids creation of a new protocol between the couple smartcard-mobile and the IrDa server. The invention provides interoperability.

Generally, the object includes information stored in the smart card. This information could be for example user information, or any other information for example able to perform security checking.

We have seen in our example that attributes are personal information attached to the smart card subscriber and in that this information is used for performing an authentication step in said second data processing system.

Preferably, the object is loaded into said first data processing system when said second data processing system needs to authenticate said smartcard CAR. The loading could be automatic. Or a message could appear on the mobile screen asking the user to accept the loading of the object. For security reason, this message could indicate the external device initiating the loading of the object.

Advantageously, connection between the first data processing system CAR and the second data processing system is directional link, and in that, once said object is loaded and stored in the first data processing system, said using step requires the user to point said first data processing system towards the second data processing system. The directional nature of infrared imposes a form of low-level security because it requires direct line-of-sight between transmitter and receiver. So the client will also have to point his mobile towards the external device each time he whishes to be identified.

Preferably, the object is stored temporarily in the first data processing system. So that, the mobile phone doesn't store any confidential information attached to the coupled smartcard. Advantageously, a message appears on the mobile phone screen indicating that the object has been loaded or deleted from the mobile phone.

For increasing security, the loading of the object into the first data processing system MOB is performed in an encrypted manner. So that, if this object includes confidential information, this will secure data transmission. In the same manner, preferably, when the object is transmitted from the mobile phone in to the server, the object is also encrypted.

Avantageously, the object attributes include attributes which value launches a service in the second data processing system SERV. This will permit an auto-launch of a service.

We see that this service has the advantage to be personal and portable since the object is stored on the smart card.

Advantageously, the client will always have the choice to activate or disable this service. If the user activates this service, said object will be loaded from the smartcard to the first data processing system. If the user deactivates the service, said object won't be loaded.

The invention also deals with a smart card CAR characterized in that said smart card stores an object including at least one subscriber attribute and in that said smart card includes a mircocontroler able to perform the step of loading said object from the smartcard into the first data processing system.

The invention also deals with a data processing system SERV such as a server able to communicate with a smart card by way of a first data processing system MOB through a network RES, characterized in that it includes a program able to perform the step of

Receiving a object from said smart card, said object including at least one subscriber attribute,

Reading the object for getting information stored in the smart card.

The invention also concerns the three following computer program products:

the first one is stored in the smart card comprises an instruction set which, when it is executed on said smart card, performs the step of loading said object from the smartcard into the first data processing system.

The second one is stored in the external device or more generally in said second data processing system and comprises an instruction set which, when it is executed on said server, performs the steps of
Receiving a object from said smart card, said class including at least one subscriber attribute,
Reading the object for getting information stored in the smart card.

The third one is stored in the mobile phone, more generally in said first data processing system. This third program comprises an instruction set which, when it is executed on said first data processing, performs the steps of
receiving said object from the smartcard;
and transmitting it to the second data processing system.

1. Communication between a smart card (CAR) coupled to a first data processing system (MOB) communicating with a second data processing system (SERV) by way of a network (RES), said first data processing system (MOB) storing at least one object defining a respective service, each object being defined by a class including at least one attribute, characterized in that it comprises the following steps:
a preliminary step in which an object is created in the smartcard (CAR), said object including at least one subscriber attribute;
a loading step in which said object is loaded in the first data processing system;
a using step in which said second data processing system uses said loaded object for getting information stored in the smart card.

2. The communication according to claim 1, characterized in that said attributes are personal information attached to the subscriber and in that this information is used for performing an authentication step in said second data processing system.

3. The communication according to claim 1 or 2, characterized in that said object is automatically loaded into said first data processing system when said second data processing system needs to authenticate said smartcard (CAR).

4. The communication according to claim 1, characterized in that, connection between the first data processing system (CAR) and the second data processing system is a directional link, and in that, once said object is loaded and stored in the first data processing system, said using step requires the user to point said first data processing system towards the second data processing system.

5. The communication according to claim 1, characterized in that the object is stored temporarily in the first data processing system.

6. The communication according to claim 1, characterized in that the loading of the object into the first data processing system (MOB) is performed in an encrypted manner.

7. The communication according to claim 1, characterized in that said object includes attributes which value launches a service in the second data processing system (SERV).

8. A smart card (CAR) able to be coupled to a first data processing system (MOB) able to communicate with a second data processing (SERV) by way of a network (RES), said first data processing system (MOB) storing at least one object defining a respective service, each object being defined by a class including at least one attribute, characterized in that said smart card stores an object including at least one subscriber attribute and in that said smart card includes a microcontroler able to perform the step of loading said object from the smartcard into the first data processing system.

9. A data processing system (SERV) such as a server able to communicate with a smart card by way of a first data processing system (MOB) through a network (RES), characterized in that it includes a program able to perform the step of
Receiving an object from said smart card, said object including at least one subscriber attribute,
Reading the object for getting information stored in the smart card.

10. A computer program product for a smart card able to be coupled to a first data processing system (MOB) able to communicate with a second data processing (SERV) by way of a network (RES), said first data processing system (MOB) storing at least one object defining a respective service, each object being defined by a class including at least one attribute, characterized in that said smart card stores an object including at least one subscriber attribute and in that the computer program product comprises an instruction set which, when it is executed on said smart card, performs the step of loading said object from the smartcard into the first data processing system.

11. A computer program product for a system (SERV) able to communicate with a smart card through a first data processing system by way of a network (RES), said first data processing system (MOB) storing at least one object defining a respective service, each object being defined by a class including at least one attribute, characterized in that the computer program product comprises an instruction set which, when it is executed on said device (SERV), performs the steps of
Receiving an object from said smart card, said object including at least one subscriber attribute,
Reading the object for getting information stored in the smart card.

12. A computer program product for a first data processing system (MOB) being able to be coupled to a smart card able, said first system MOB being able able to communicate with a second data processing (SERV) by way of a network (RES), said first data processing system (MOB) storing at least one object defining a respective service, each object being defined by a class including at least one attribute, characterized in that said smart card stores an object including at least one subscriber attribute and in that the computer program product comprises an instruction set which, when it is executed on said first data processing, performs the steps of
receiving said object from the smartcard;
transmitting it to the second data processing system.
